(19) United States
(12) Patent Application Publication
(10) Pub. No.: US 2018/0112685 A1
(43) Pub. Date: Apr. 26, 2018

(54) SYSTEM AND METHOD FOR CONTROLLING OPERATION OF HYDRAULIC VALVE

(71) Applicant: Caterpillar Inc., Peoria, IL (US)

(72) Inventors: Matthew J. Beschorner, Plainfield, IL (US); Dustin K. Fee, Peoria, IL (US); Ioan Paduret, Peoria, IL (US); David J. Subert, Chillicothe, IL (US)

(73) Assignee: Caterpillar Inc., Peoria, IL (US)

(21) Appl. No.: 15/299,513

(22) Filed: Oct. 21, 2016

(51) Int. Cl. F15B 13/04; F16K 31/06; F16K 11/07; F16K 27/00; F16K 37/00; G05D 7/06

(52) U.S. Cl. CPC F15B 13/0402; F16K 31/0613; F16K 11/0716; F15B 2211/426; F16K 37/0025; G05D 7/0635; F16K 27/003

(57) ABSTRACT

A system for controlling operation of a hydraulic valve is provided. The system includes a solenoid coupled to a spool assembly of the hydraulic valve. The system further includes a sensor disposed on the hydraulic valve. The sensor generates signals indicative of operational parameter of the hydraulic valve. The system also includes a controller in communication with the solenoid and the sensor. The controller receives signals generated by the sensor. The controller includes a booster circuit connected to the solenoid. The booster circuit boosts an actuating current generated in response to the signals received from the sensor. The controller further includes a switching circuit connected across the solenoid. The switching circuit controls a direction of the actuating current flowing through the solenoid. The solenoid actuates the spool assembly of the hydraulic valve to control the operation of the hydraulic valve based on the actuating current.

### TECHNICAL FIELD

The present disclosure relates to a hydraulic system, and more particularly relates to a system and a method for controlling operation of a hydraulic valve of the hydraulic system.

### BACKGROUND

Machines, such as excavators and loaders, include hydraulic system for operating various systems, such as an implement system, a lubrication system, and a braking system. The hydraulic system includes one or more hydraulic valves for controlling flow of fluid to multiple actuators, such as a hydraulic cylinder, through multiple hydraulic lines. The hydraulic valve includes a hollow spool for selectively allowing or restricting flow of fluid from pump to multiple actuators. Generally, the hydraulic valve may have considerably less frequency response range, for example, 7 Hz to 8 Hz at a 90 degree phase. Typically, the hydraulic valve is controlled by an electronic control module (ECM) of the machine. The hydraulic valve has a solenoid that is in electronic communication with the ECM of the machine. The ECM energizes or de-energizes the solenoid for controlling movement of the spool to operate the hydraulic valve. The machine includes mechanical devices, such as mechanical compensators and line relief valves, for enhancing the frequency response of the hydraulic valve. However, in conventional hydraulic valve, advanced programmable features of the ECM may not be implemented effectively due to design limitations of the hydraulic valve components, such as spools, and the less frequency response of the hydraulic valve.

U.S. Pat. No. 8,006,718, hereinafter referred to as ‘the '718 patent, discloses a sleeve having an input port, an output port, an insertion hole, and a discharge port. A spool is axially slidable through the insertion hole to communicate among the input port, the output port, and the discharge port. An electric actuator is provided to one end of the sleeve and has a variable volume chamber, which communicates with the discharge port through an axial through hole and a spool breathing hole in the spool. The spool has a communication through hole to lead fluid from the output port to the discharge port through the axial through hole. A passage partition member is in the axial through hole to define an in-spool breathing passage communicating with the spool breathing hole. However, the '718 patent fails to disclose an effective method to increase the frequency response of the hydraulic valve.

### SUMMARY OF THE DISCLOSURE

In one aspect of the present disclosure, a system for controlling operation of a hydraulic valve is provided. The system includes a solenoid coupled to a spool assembly of the hydraulic valve. The system further includes a sensor disposed on the hydraulic valve. The sensor is configured to generate signals indicative of one or more operational parameters of the hydraulic valve. The system also includes a controller in communication with the solenoid and the sensor. The controller is configured to receive signals generated by the sensor. The controller includes a booster circuit connected to the solenoid. The booster circuit is configured to boost an actuating current generated in response to the signals received from the sensor. The controller further includes a switching circuit connected across the solenoid. The switching circuit is configured to control a direction of the actuating current flowing through the solenoid. The solenoid is configured to actuate the spool assembly within a valve body of the hydraulic valve to control the operation of the hydraulic valve based on the actuating current.

In another aspect of the present disclosure, a method of controlling operation of a hydraulic valve is provided. The method includes generating signals indicative of one or more operational parameters of the hydraulic valve by a sensor. The method further includes receiving the signals generated by the sensor by a controller. The method also includes generating an actuating current in response to the signals received from the sensor by the controller. The method also includes actuating a spool assembly of the hydraulic valve based on the actuating current by a solenoid and controlling the actuating current by a booster circuit and a switching circuit associated with the controller.

In yet another aspect of the present disclosure, a method of controlling operation of a hydraulic valve is provided. The method includes generating signals indicative of one or more operational parameters of the hydraulic valve by a sensor. The method also includes receiving the signals generated by the sensor by a controller. The method also includes generating an actuating current in response to the signals received from the sensor by the controller. The method also includes actuating a spool assembly of the hydraulic valve based on the actuating current by a solenoid. The method also includes controlling the actuating current by boosting the actuating current flowing through the solenoid by a booster circuit and controlling a direction of the actuating current flowing through the solenoid by a switching circuit.

Other features and aspects of this disclosure will be apparent from the following description and the accompanying drawings.

### BRIEF DESCRIPTION OF THE DRAWINGS

FIG. 1 is a schematic diagram of a hydraulic circuit having hydraulic valves, according to one embodiment of the present disclosure;

FIG. 2 is a schematic diagram of a system for controlling operation of the hydraulic valves of FIG. 1, according to one embodiment of the present disclosure;

FIG. 3 is a schematic block diagram of a controller of the system of FIG. 2, according to one embodiment of the present disclosure; and

FIG. 4 is a flow chart of a method of controlling operation of the hydraulic valves of FIG. 1, according to one embodiment of the present disclosure.

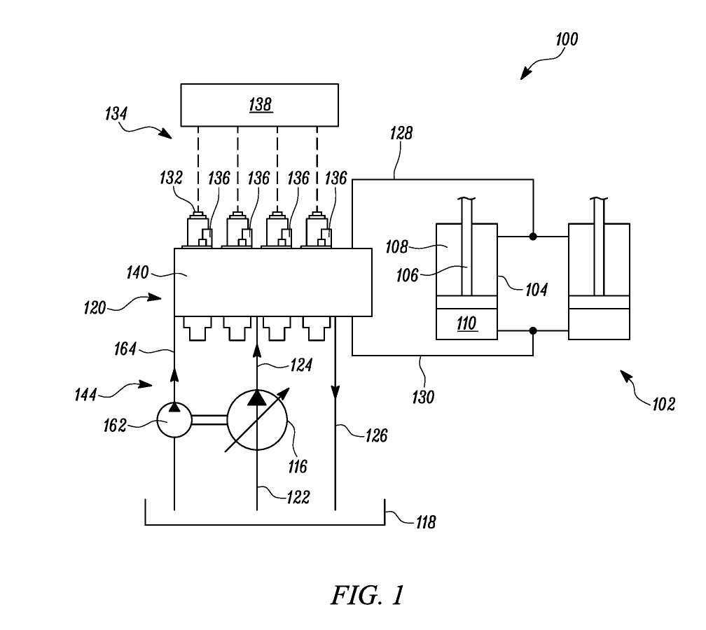

### DETAILED DESCRIPTION

Wherever possible, the same reference numbers will be used throughout the drawings to refer to the same or the like parts. FIG. 1 illustrates an exemplary hydraulic circuit 100 for operating one or more tool actuators 102. The one or more tool actuators 102 may be used in machines (not shown), such as excavators, loaders, and other machines having implements for performing earth moving operations and other known industrial operations. The one or more tool actuators 102 are movable based on an input received from an operator of the machine. Referring to FIG. 1, two tool actuators 102 are shown that are arranged to operate in tandem. The one or more tool actuators 102 are hereinafter referred to as “the tool actuator 102”. In one example, the tool actuator 102 is a linear actuator, such as a cylinder with piston arrangement.

In the illustrated embodiment, the tool actuator 102 includes a tube 104 and a piston 106 arranged within the tube 104 to form a first chamber 108 and a second chamber 110. The first chamber 108 and the second chamber 110 may be selectively supplied with pressurized fluid to cause the piston 106 to displace within the tube 104, and thereby changing an effective length of the tool actuator 102.

The hydraulic circuit 100 includes a pump 116 configured to draw fluid from a sump 118, to pressure the fluid, and to direct the fluid through a valve assembly 120 to the tool actuator 102. The pump 116 may be fluidly connected to the sump 118 by a suction passage 122, and to the valve assembly 120 via a pressure passage 124. The pump 116 may be driven by a power source, such as an engine of the machine. The sump 118 is connected to the valve assembly 120 via a drain passage 126. The hydraulic circuit 100 may also include various control valves (not shown), such as relief valves, check valves, directional control valves, in fluid communication with the drain passage 126 and the pressure passage 124 to maintain a desired pressure of the fluid within the hydraulic circuit 100.

The valve assembly 120 is in fluid communication with the first chamber 108 and the second chamber 110 of the tool actuator 102 via a rod end passage 128 and a head end passage 130, respectively. The valve assembly 120 selectively controls flow of the fluid to the head end passage 130 and the rod end passage 128 to cause movement of the piston 106 of the tool actuator 102. The valve assembly 120 includes multiple hydraulic valves 132 for controlling the flow of fluid into and out of the head end passage 130 and the rod end passage 128. One hydraulic valve 132 of the multiple hydraulic valves 132 of the valve assembly 120 is explained in detail hereinafter. The hydraulic circuit 100 includes a system 134 that is in communication with the hydraulic valve 132. The system 134 is configured to receive the input provided by the operator and control an operation of the hydraulic valve 132. The system 134 includes multiple solenoids 136. Each of the multiple solenoids 136 is coupled to one of the hydraulic valve 132 of the multiple hydraulic valves 132. The system 134 further includes a controller 138 in communication with the multiple solenoids 136. For explanatory purpose, one solenoid 136 of the multiple solenoids 136 is explained in detail hereinafter. The functionalities of the system 134 and various components of the system 134 are explained in detail hereinbelow.

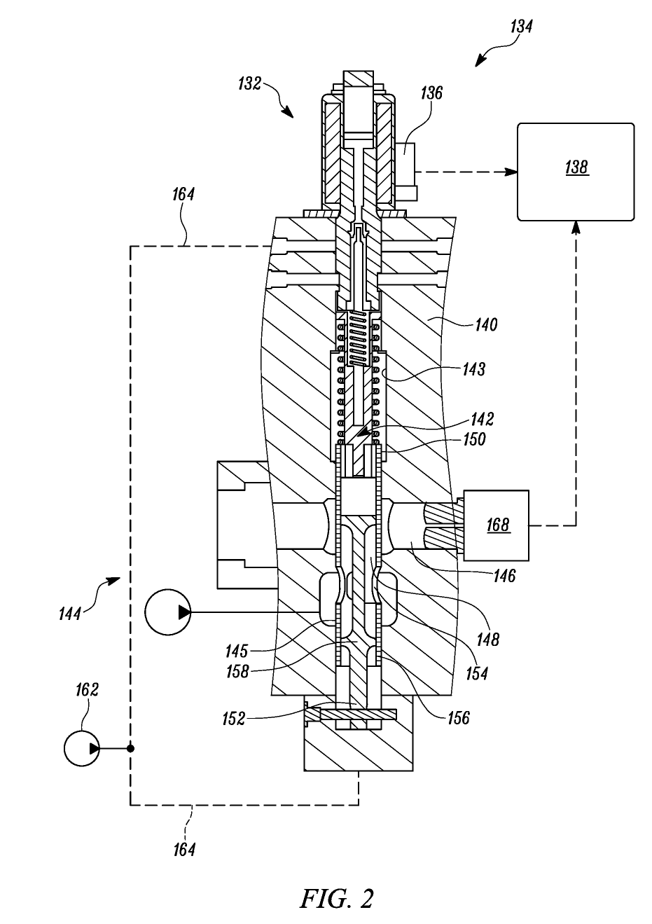

FIG. 2 illustrates a schematic diagram of the system 134 for controlling the operation of the hydraulic valve 132, according to an embodiment of the present disclosure. In one embodiment, the hydraulic valve 132 includes a valve body 140, a spool assembly 142 slidably disposed within a bore 143 defined in the valve body 140, and an actuator 144 to control movement of the spool assembly 142 within the valve body 140. The valve body 140 of each of multiple hydraulic valves 132 may be fastened to form the valve assembly 120. In an alternate embodiment, the valve assembly 120 includes a single valve body (as shown FIG. 1) and multiple spool assemblies disposed within multiple bores defined in the single valve body 140. Also, multiple actuators are connected to the single valve body. The hydraulic valve 132 includes an inlet port 145 and an outlet port 146 defined in the valve body 140. The flow of fluid from the inlet port 145 to the outlet port 146 is controlled by the spool assembly 142.

The spool assembly 142 includes a hollow cylindrical body 148 extending from a first end 150 to a second end 152. The hollow cylindrical body 148 includes multiple radial orifices 154 in a wall 156 of the hollow cylindrical body 148. The spool assembly 142 further includes an insert 158 slidably disposed inside the hollow cylindrical body 148. A linear movement of the spool assembly 142 within the valve body 140 hydraulically connects the inlet port 145 with the outlet port 146 of the hydraulic valve 132. The hydraulic valve 132 controls the flow of the fluid by controlling the axial movement of the spool assembly 142 within the valve body 140.

Referring to FIG. 1 and FIG. 2, the actuator 144 is a pilot line. The pilot line may be fluidly connected to the second end 152 of the spool assembly 142. The pilot line may cause the spool assembly 142 of the hydraulic valve 132 to move between different positions. The pilot line allows pilot fluid to flow from a pilot pump 162 through a pilot passage 164 to the hydraulic valve 132. The pilot line can also include an accumulator to maintain a desired pressure of the pilot fluid in the pilot line during actuation of the hydraulic valve 132. In another embodiment, the hydraulic valve 132 may be actuated by a linear motor (not shown) operatively coupled to the spool assembly 142. In yet another embodiment, the actuator 144 that is drivably coupled to the spool assembly 142 may be a proportional pressure reducing valve known in the art.

As mentioned earlier, the operation of the hydraulic valve 132 is controlled by the system 134 in response to various operating parameters of the hydraulic valve 132, such as a flow rate of the fluid, and a pressure of the fluid communicated with the tool actuator 102. The solenoid 136 of the system 134 is coupled to the spool assembly 142 of the hydraulic valve 132. The solenoid 136 is an electromagnetic-inductive coil movably wound around a plunger (not shown). The plunger is movably coupled to the spool assembly 142. The solenoid 136 is configured to generate a magnetic field when energized by an actuating current. Based on the magnetic field, the plunger may exhibit a linear motion. The movement of the plunger is controlled by a magnitude and a direction of the actuating current applied to the solenoid 136. More specifically, the solenoid 136 may have an electrical characteristic of an inductor such as opposing a flow of the actuating current through the solenoid 136. Hence, the actuating current rises at a steady rate until it is limited by a DC resistance of the solenoid 136. As soon as the solenoid 136 is energized, the actuating current increases and causes the magnetic field to expand until it becomes strong enough to move the plunger of the solenoid 136. Thus, the spool assembly 142 of the hydraulic valve 132 moves to establish a fluid connection between the inlet port 145 and the outlet port 146. When the solenoid 136 is de-energized, the spool assembly 142 of the hydraulic valve 132 moves to disconnect a fluid connection between the inlet port 145 and the outlet port 146.

The system 134 further includes a sensor 168 disposed in the hydraulic valve 132. The sensor 168 is configured to generate signals indicative of one or more operational parameters of the hydraulic valve 132 including, but not limited to, the pressure of the fluid, and a displacement of the spool assembly 142 within the valve body 140. In one embodiment, the sensor 168 may be a pressure sensor configured to generate signals indicative of the pressure of the fluid flowing through the hydraulic valve 132. The pressure sensor may be disposed at the outlet port 146 of the hydraulic valve 132. In another embodiment, the pressure sensor may be disposed at the inlet port 145 of the hydraulic valve 132. In other embodiments, the sensor 168 may be disposed at any location in the hydraulic valve 132 to detect pressure of the fluid flowing through the hydraulic valve 132. In another embodiment, the sensor 168 may be a displacement sensor configured to generate signals indicative of the displacement of the spool assembly 142 within the valve body 140 of the hydraulic valve 132. The displacement of the spool assembly 142 within the valve body 140 indicates amount of fluid flowing from the inlet port 145 to the outlet port 146.

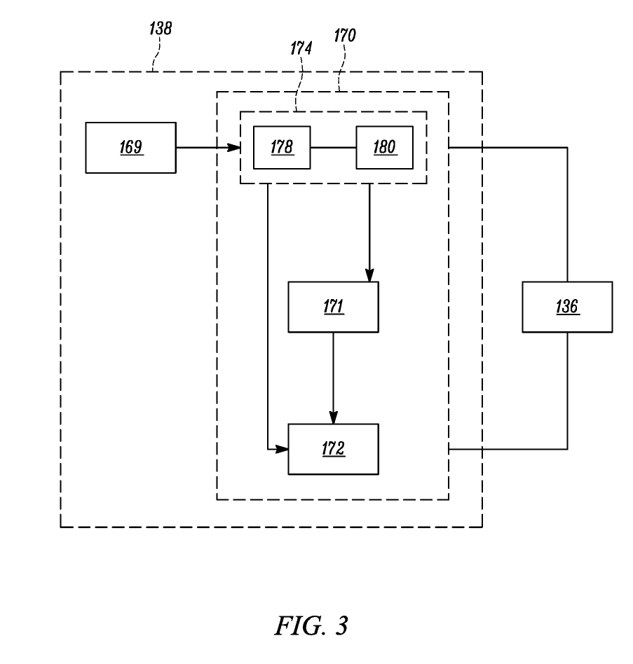

The controller 138 of the system 134 is in communication with the solenoid 136 and the sensor 168. The controller 138 implements a communication channel, such as Controller Area Network (CAN) to communicate with the sensor 168 and the solenoid 136. In one embodiment, the controller 138 is an Electronic Control Module (ECM) of the engine of the machine. The controller 138 may be an embedded system configured to provide real time regulation for the hydraulic valve 132. The controller 138 may include a processor including a single processing unit or multiple processing units, each of which may include a plurality of computing units. The controller 138 may be implemented as one or more microprocessors, microcomputers, digital signal processor, central processing units, state machine, logic circuitries, and any device that is capable of manipulating signals based on operational instructions. Among the capabilities mentioned herein, the controller 138 may also be configured to receive, transmit, and execute computer-readable instructions. In an embodiment, the controller 138 may be implemented in the machine to control various components of the machine including, but not limited to, a transmission system, a braking system, a suspension system, an exhaust system, a steering system, and an implement system. The functionalities of the controller 138 and various modules of the controller 138 are explained in detail with reference to FIG. 3. In another embodiment, the machine may include multiple controllers 138 configured to control one of various components of the machine including, but not limited to, the transmission system, the braking system, the suspension system, the exhaust system, the steering system, and the implement system. Each of the multiple controllers 138 is configured to communicate with each other for collectively controlling an operation of the machine.

In an embodiment, the controller 138 is configured to generate an actuating current I₁ at time T₁ in response to the input provided by the operator to actuate the spool assembly 142 of the hydraulic valve 132. The actuating current I₁ is communicated to the solenoid 136 for actuating the spool assembly 142 to operate the hydraulic valve 132. Thus, the spool assembly 142 of the hydraulic valve 132 allows the fluid connection between the inlet port 145 and the outlet port 146 of the hydraulic valve 132. The solenoid 136 initiates the axial movement of the spool assembly 142 of the hydraulic valve 132 based on the actuating current I₁. The sensor 168 disposed in the hydraulic valve 132 may act as a feedback signaling device. The sensor 168 senses the operational parameters of the hydraulic valve 132 during the operation of the hydraulic valve 132 and generates the signals indicative of the operational parameters of the hydraulic valve 132. Further, the generated signals are communicated to the controller 138 for regulating the operation of the hydraulic valve 132. The controller 138 is configured to receive the signals generated by the sensor 168. The controller 138 is configured to determine the operational parameters from the signals and to generate a compensating current in response to the signals received from the sensor 168. The controller 138 is further configured to generate an actuating current I₂ at time T₂ based on the compensating current and the input provided by the operator.

FIG. 3 illustrates a schematic block diagram of the controller 138 of the system 134, according to one embodiment of present disclosure. The controller 138 includes a controlling module 169 and a processing module 170. The controlling module 169 is configured to generate the actuating current in response to the input received from the operator and the signals received from the sensor 168. The actuating current generated by the controlling module 169 is communicated to the processing module 170. The processing module 170 includes a booster circuit 171. The actuating current required to energize or de-energize the solenoid 136 is referred to as ‘the peak current’. The booster circuit 171 boosts the actuating current to increase the magnitude thereof till a magnitude of the peak current reaches. Further, the boosted actuating current is supplied to the solenoid 136 to energize the solenoid 136 to establish the fluid connection between the inlet port 145 and the outlet port 146. Also, the boosted actuating current is supplied to the solenoid 136 to de-energize the solenoid 136 to disconnect the fluid connection between the inlet port 145 and the outlet port 146. The booster circuit 171 amplifies the actuating current at voltage up to 105V over milliseconds. In one embodiment, the booster circuit 171 may be a voltage boost driver known in the art.

The processing module 170 further includes a switching circuit 172 connected across the solenoid 136. The switching circuit 172 is configured to connect the solenoid 136 with at least one of a battery of the machine and the boost circuit 171. The switching circuit 172 controls the direction of the actuating current flowing through the solenoid 136. The switching circuit 172 is connected across the solenoid 136, such that the direction of the actuating current may be switched in forward or reverse directions. In the present embodiment, the switching circuit 172 is a H-bridge.

The processing module 170 further includes a digital logic circuit 174. The digital logic circuit 174 includes a processor 178 and a field programmable gate array (FPGA) 180. The actuating current required to maintain the energized or de-energized state of the solenoid 136 is referred to as ‘the holding current’. The holding current is significantly less than the peak current. In order to bring the magnitude of the actuating current to a magnitude of the holding current in the solenoid 136 for a predetermined time, the digital logic circuit 174 implements a proportional logic known in the art, without limiting the scope of the present disclosure. The proportional logic derives the holding current from the actuating current for holding the solenoid 136 at the energized state and hence to maintain desired flow rate of the fluid between the inlet port 145 and the outlet port 146 of the hydraulic valve 132. The digital logic circuit 174 holds the actuating current at a voltage provided by at least one of the battery and the boost circuit 171 for the predetermined time. The predetermined time is defined as a time interval for which the solenoid 136 needs to be energized to keep the spool assembly 142 at an open position and hence to establish the fluid communication between the inlet port 145 and the outlet port 146. The predetermined time may also be defined as the time interval for which the solenoid 136 needs to be de-energized to keep the spool assembly 142 at a closed position to disconnect the fluid communication between the inlet port 145 and the outlet port 146.

The actuating current generated by the controlling module 169 is boosted by the booster circuit 171 for a predefined time period. In an example, the predefined time period may be 2 milliseconds. The booster circuit 171 boosts the actuating current to the peak current by boosting an input voltage provided to the booster circuit 171. The actuating current spikes to reach the peak current required for energizing or de-energizing the solenoid 136 due to the boosting of the input voltage. Further, the FPGA 180 of the digital logic circuit 174 is configured to induce a dither in the actuating current. The dither is a ripple frequency that is superimposed over the actuating current applied to the solenoid 136, which causes a desired movement of the spool assembly 142 of the hydraulic valve 132. The application of dither leverages the energizing and de-energizing state thereby increases the frequency response of the solenoid 136. In another embodiment, the booster circuit 171 is a current booster circuit.

The switching circuit 172 is connected across the solenoid 136 for controlling the direction of the actuating current. The FPGA 180 of the digital logic circuit 174 is connected to the switching circuit 172 to control the switching circuit 172. More specifically, the switching circuit 172 includes at least two pairs of switching devices (not shown). In one example, the pair of switching devices is Field Effect Transistors (FETs). Each pair of the switching devices is controlled by the FPGA 180. For example, the FPGA 180 is configured to turn ON and turn OFF each pair of the switching devices to apply the actuating current through the solenoid 136 in the forward or reverse directions. The first pair of switching devices is controlled by the FPGA 180 to direct the actuating current in to the solenoid 136. The second pair of the switching devices is controlled by the FPGA 180 to direct the actuating current out of the solenoid 136. The direction of flow of the actuating current is directly proportional to a direction of magnetic field generated by the solenoid 136 and the direction of movement of the plunger. Hence, the implementation of the switching circuit 172 controls the linear movement of the spool assembly 142 within the valve body 140 with limited time delay thereby increasing the frequency response of the hydraulic valve 132.

In another embodiment, the controller 138 may include multiple processing modules 170. Each of the multiple processing modules 170 is coupled to one of the multiple solenoids 136. The multiple processing modules 170 are configured to communicate with each other for coordinating an operation of the multiple hydraulic valves 132 of the valve assembly 120. In yet another embodiment, the system 134 may include multiple controllers 138. Each of the multiple controllers 138 includes at least one processing module 170. Each of the multiple controllers 138 is configured to communicate to each other. Each of the multiple controllers 138 is coupled to one of the multiple solenoids 136 to control the operation of the valve assembly 120.

### INDUSTRIAL APPLICABILITY

The present disclosure relates to the system 134 and a method 182 for controlling the operation of the hydraulic valve 132. The system 134 improves the frequency response of the hydraulic valve 132 by reducing the response time. The booster circuit 171 is capable of boosting the actuating current till the peak current required to energize and de-energize the solenoid 136 within a short time interval, for example 2 milliseconds. The boosting of the actuating current within the short time interval increases the frequency response of the solenoid 136. The switching circuit 172 drives energy in and out of the solenoid 136. The digital logic circuit 174 is configured to regulate the flow of the actuating current through the solenoid 136. Further, the spool assembly 142 of the hydraulic valve 132 includes the hollow cylindrical body 148. The hollow cylindrical body 148 of the spool assembly 142 reduces the amount of fluid that needs to be purged through the spool assembly 142, which in turns makes movement of the spool assembly 142 faster than the conventional spools.

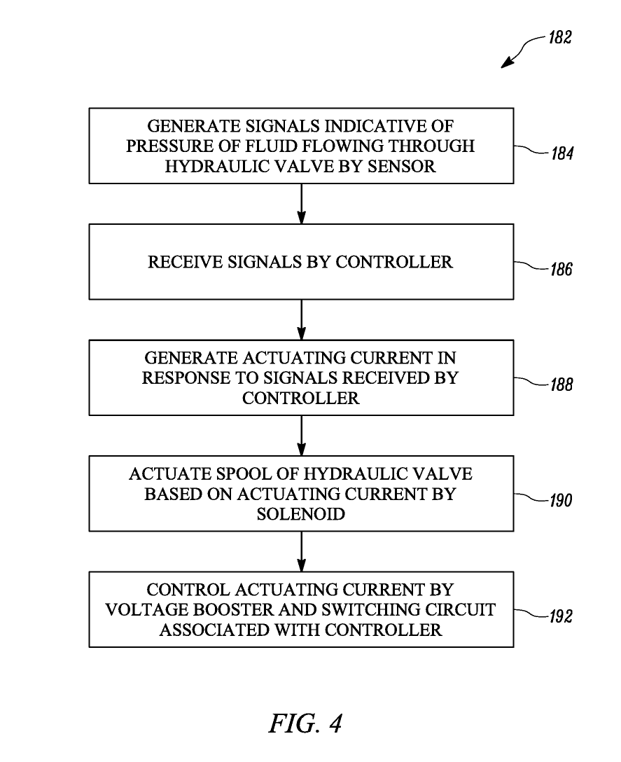

FIG. 4 illustrates a flow chart of the method 182 of controlling the operation of the hydraulic valve 132. For the sake of brevity, various embodiments of the present disclosure, which are already explained in detail in the description of FIG. 1, FIG. 2, and FIG. 3, are not explained in detail with regard to the description of the method 182. As mentioned earlier, the hydraulic valve 132 is controlled by the solenoid 136, which is attached to the spool assembly 142 of the hydraulic valve 132. The spool assembly 142 moves within the valve body 140 based on the input received by the solenoid 136 to establish or disconnect the fluid connection between the inlet port 145 and the outlet port 146 of the hydraulic valve 132.

At step 184, the method 182 includes generating the signals indicative of the one or more operational parameters of the hydraulic valve 132 by the sensor 168. The sensor 168 includes, but not limited to, the pressure sensor and the displacement sensor. The operational parameter may include pressure of the fluid flowing through the inlet port 145 and the outlet port 146 of the hydraulic valve 132. The operational parameters further include displacement of the spool assembly 142. The signals generated by the sensor 168 may act as a feedback signal to the controller 138.

At step 186, the method 182 includes receiving the signals by the controller 138. The signals enable the controller 138 to determine a change in the actuating current required to meet the desired displacement of the spool assembly 142 of the hydraulic valve 132. At step 188, the method 182 further includes generating the actuating current in response to the signals received from the sensor 168 by the controller 138 and the input provided by the operator. As mentioned earlier, the controller 138 includes the controlling module 169 for generating the actuating current corresponding to the signals.

At step 190, the method 182 includes actuating the spool assembly 142 of the hydraulic valve 132 based on the actuating current by the solenoid 136. The controller 138 communicates the actuating current with the solenoid 136. The actuating current energizes and de-energizes the solenoid 136, which in turn causes the linear movement of the spool assembly 142 from the closed position to the open position within the valve body 140. The linear movement of the spool assembly 142 fluidly connects the inlet port 145 and the outlet port 146 of the hydraulic valve 132. The solenoid 136 is coupled to the first end 150 of the spool assembly 142 and the actuator 144 is coupled to the second end 152 of the spool assembly 142. The solenoid 136 actuates the spool assembly 142 within the valve body 140 of the hydraulic valve 132 in response to the actuation of the spool assembly 142 by the actuator 144. In one embodiment, the actuator 144 is the pilot line in fluid communication with the hydraulic valve 132.

At step 192, the method 182 includes controlling the actuating current by the booster circuit 171 and the switching circuit 172 to enhance the frequency response of the solenoid 136 thereby reducing the time delay in energizing and de-energizing the solenoid 136. Controlling the actuating current includes boosting the actuating current flowing through the solenoid 136 by the booster circuit 171. The solenoid 136 may require approximately 30% more actuating current while energizing the solenoid 136 than the actuating current generated by the controlling module 169. Hence, the booster circuit 171 boosts the actuating current to the peak current. The controlling of the actuating current further includes controlling the direction of the actuating current flowing through the solenoid 136 by the switching circuit 172. As mentioned earlier, the switching circuit 172 includes at least two pairs of switching devices. The first pair of switching devices is enabled by the FPGA 180 to direct the actuating current into the solenoid 136. The second pair of the switching devices is enabled by the FPGA 180 to direct the actuating current out of the solenoid 136. Controlling the actuating current also includes controlling the flow of the actuating current in the solenoid 136 for the predetermined time by the proportional logic of the digital logic control 174.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A system for controlling operation of a hydraulic valve, the system comprising:
a solenoid coupled to a spool assembly of the hydraulic valve;
a sensor disposed on the hydraulic valve, and configured to generate signals indicative of one or more operational parameters the hydraulic valve; and
a controller in communication with the solenoid and the sensor, the controller configured to receive signals generated by the sensor, the controller comprising:
a booster circuit connected to the solenoid, and configured to boost an actuating current generated in response to the signals received from the sensor; and
a switching circuit connected across the solenoid, and configured to control a direction of the actuating current flowing through the solenoid,
wherein the solenoid is configured to actuate the spool assembly within a valve body of the hydraulic valve to control the operation of the hydraulic valve based on the actuating current.

2. The system of claim 1, wherein the controller comprises a digital logic circuit configured to control a flow of the actuating current in the solenoid for a predetermined time.

3. The system of claim 1, wherein the sensor is disposed at an output port of the hydraulic valve.

4. The system of claim 1, wherein the spool assembly of the hydraulic valve comprises a hollow cylindrical body having a first end coupled to the solenoid and a second end in fluid communication with an actuator, and wherein the solenoid is configured to actuate the spool assembly within the valve body of the hydraulic valve in response to an actuation of the spool assembly by the actuator.

5. The system of claim 4, wherein the actuator is a pilot fluid line in fluid communication with the hydraulic valve.

6. The system of claim 4, wherein the actuator is a linear motor drivably coupled to the spool assembly.

7. A method of controlling operation of a hydraulic valve, the method comprising:
generating, by a sensor, signals indicative of one or more operational parameters of fluid flowing through the hydraulic valve;
receiving, by a controller, the signals generated by the sensor;
generating, by the controller, an actuating current in response to the signals received from the sensor;
actuating, by a solenoid, a spool assembly of the hydraulic valve based on the actuating current; and
controlling the actuating current by a booster circuit and a switching circuit associated with the controller.

8. The method of claim 7, further comprising boosting, by the booster circuit, the actuating current flowing through the solenoid.

9. The method of claim 7, further comprising controlling, by the switching circuit, a direction of the actuating current flowing through the solenoid.

10. The method of claim 7, further comprising controlling, by a digital logic circuit, a flow of the actuating current in the solenoid for a predetermined time.

11. The method of claim 7, wherein the sensor is disposed at an output port of the hydraulic valve.

12. The method of claim 7 further comprising actuating, by the solenoid, the spool assembly within a valve body of the hydraulic valve in response to an actuation of the spool assembly by an actuator, wherein the solenoid is coupled to a first end of the spool assembly and the actuator is coupled to a second end of the spool assembly.

13. The method of claim 12, wherein the actuator is a pilot fluid line in fluid communication with the hydraulic valve.

14. A method of controlling operation of a hydraulic valve, the method comprising:
generating, by a sensor, signals indicative of one or more operational parameters of fluid flowing through the hydraulic valve;
receiving, by a controller, the signals generated by the sensor;
generating, by the controller, an actuating current in response to the signals received from the sensor;
actuating, by a solenoid, a spool of the hydraulic valve based on the actuating current; and
controlling the actuating current comprising:
boosting, by a booster circuit, the actuating current flowing through the solenoid; and
controlling, by a switching circuit, a direction of the actuating current flowing through the solenoid.

15. The method of claim 14, further comprising controlling, by a digital logic circuit, a flow of the actuating current in the solenoid for a predetermined time.

16. The method of claim 14, wherein the sensor is disposed at an output port of the hydraulic valve.

17. The method of claim 14 further comprising actuating, by the solenoid, the spool assembly within a valve body of the hydraulic valve in response to an actuation of the spool assembly by an actuator, wherein the solenoid is coupled to a first end of the spool assembly and the actuator is coupled to a second end of the spool assembly.

18. The method of claim 17, wherein the actuator is a pilot fluid line in fluid communication with the hydraulic valve.
